(19) United States
(12) Patent Application Publication
(10) Pub. No.: US 2025/0074823 A1
(43) Pub. Date: Mar. 6, 2025

(54) GYPSUM BOARDS PREPARED USING ECO-FRIENDLY DISPERSANTS AND RELATED SLURRIES AND METHODS

(71) Applicant: United States Gypsum Company, Chicago, IL (US)

(72) Inventor: Annamaria VILINSKA, Chicago, IL (US)

(73) Assignee: United States Gypsum Company, Chicago, IL (US)

(21) Appl. No.: 18/749,488

(22) Filed: Jun. 20, 2024

Related U.S. Application Data
(60) Provisional application No. 63/580,276, filed on Sep. 1, 2023.

(51) Int. Cl. C04B 24/18; B32B 13/02; B32B 13/08; B32B 37/15; B32B 38/00; C04B 28/14; C04B 103/30; C04B 111/00

(52) U.S. Cl. CPC C04B 24/18; B32B 13/02; B32B 13/08; B32B 37/153; B32B 38/0004; C04B 28/14; B32B 2250/03; B32B 2250/40; B32B 2315/00; B32B 2419/00; C04B 2103/302; C04B 2111/0062

(57) ABSTRACT

Disclosed are gypsum slurries, gypsum boards, and methods of preparing gypsum board using a high-efficiency lignosulfonate dispersant. The high-efficiency lignosulfonate surprisingly and unexpectedly allows for enhancing the fluidity of the gypsum slurry without requiring the presence of dispersants that are biologically detrimental (including to human and environmental health), or are prepared using harmful materials such as aldehydes (e.g., formaldehyde). In embodiments, the presence of the high-efficiency lignosulfonate allows for excluding a synthetic dispersant such as polynapthalene sulfonate (PNS) or melamine sulfonate.

### CROSS-REFERENCE TO RELATED APPLICATION

This patent application claims the benefit of U.S. Provisional Patent Application 63/580,276, filed Sep. 1, 2023, which is incorporated by reference.

### BACKGROUND

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board).

During manufacture of the board, the stucco, water, and other ingredients as appropriate are mixed, typically in a wallboard slurry mixer as the term is used in the art. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like.

The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. The calcined gypsum reacts with the water in the wallboard preform and sets as a conveyor moves the wallboard preform down a manufacturing line. The wallboard preform is cut into segments at a point along the line where the preform has set sufficiently. Heat is typically used (e.g., in a kiln) to drive off the remaining free (i.e., unreacted) water to yield a dry product.

Prior compositions and methods for addressing some of the operational problems associated with the production of gypsum wallboard are disclosed in commonly-assigned U.S. Pat. Nos. 5,683,635; 5,643,510; 6,494,609; 6,874,930; 7,007,914; 7,296,919; 8,062,741; 8,329,308; 9,828,441; 10,362,786; 10,399,899; 10,464,847; 10,968,138; 11,135,818; and 11,674,317; and U.S. Patent Publications 2006/0278135 and 2008/0148997, which are incorporated by reference. There is a continued need in the art to provide additional solutions to enhance the production of cementitious boards.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### BRIEF SUMMARY

The disclosure provides a gypsum board, a gypsum slurry, and a method of preparing the gypsum board using a high-efficiency lignosulfonate dispersant as described herein, and excluding a polynaphthalene sulfonate and melamine sulfonate dispersant. The gypsum board can be in the form of wallboard. As used herein, the term “wallboard” is not limited to the use of the board on walls, but can also include boards used for ceilings, partitions, etc. The board includes a set gypsum core disposed between first and second cover sheets (commonly face and back sheets, respectively). The set gypsum core is formed from a gypsum slurry comprising stucco, water, the high-efficiency lignosulfonate dispersant, and optional ingredients as desired, including, for example, foaming agent, accelerator (e.g., heat resistant accelerator), retarder, strength-enhancing starch, migrating starch, and polyphosphate. The face side of the board normally is facing out and is visible when hanging in use, while the back side faces inward, toward support structures such as studs.

Surprisingly and unexpectedly, the high-efficiency lignosulfonate dispersant advantageously provides good performance with respect to fluidity and water-demand, and can therefore be used as a substitute for synthetic dispersants, such as polynaphthalene sulfonate (PNS) and/or melamine sulfonate dispersants. Naphthalene sulfonates generally used in the art are typically synthetically produced and may include DILOFLO®, available from GEO® Specialty Chemicals, Cleveland, Ohio; DAXAD®, available from Hampshire Chemical Corp., Lexington, Massachusetts; and LOMAR D®, available from GEO® Specialty Chemicals, Lafayette, Indiana. In this regard, certain conventional synthetic dispersants, such as PNS and melamine sulfonate dispersants, may be formed from chemicals which are believed to be biologically or environmentally harmful, such as through condensation polymerization with formaldehyde. Aldehydes, including formaldehyde, are often known carcinogens and are considered “red-listed” chemicals for posing certain deleterious health effects, as discussed herein.

As described herein, surprisingly and unexpectedly, in an aspect, the high-efficiency lignosulfonate dispersant is characterized by providing and/or enhancing the fluidity of a gypsum slurry comparable (e.g., equal or greater than) to the fluidity enhancement provided by polynaphthalene sulfonate of the same gypsum slurry absent the high-efficiency lignosulfonate dispersant but containing the same amount of the polynaphthalene sulfonate instead. In addition, as described herein, in an aspect, the high-efficiency lignosulfonate dispersant is characterized by providing a water demand comparable (e.g., equal or less than) to the water demand of the same slurry absent the high-efficiency lignosulfonate dispersant but containing the same amount of the polynaphthalene sulfonate instead.

Thus, in one aspect, the present disclosure provides a gypsum slurry comprising water, stucco, and a high-efficiency lignosulfonate dispersant, while excluding the use of polynaphthalene sulfonate dispersants (PNS) and melamine sulfonate dispersants. In some embodiments, high-efficiency is a measurement of dosage needed to achieve a sufficient gypsum slurry fluidity and is determined by testing the gypsum slurry flowability at different dosages until a desired spread is achieved such that the lignosulfonate demonstrates comparable slurry fluidities at identical dosages as polynaphthalene sulfonates.

In embodiments, the slurry exhibits a fluidity that is the same or greater than the fluidity produced by an otherwise identical slurry (e.g., having the same water/stucco ratio (WSR)) containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the slump fluidity spread (SFS) test as described herein. See also U.S. Pat. No. 10,968,138.

In another aspect of the invention, the disclosure provides a gypsum board comprising set gypsum core disposed between two cover sheets. The core is formed from a slurry comprising stucco, water, and a high-efficiency lignosulfonate dispersant, while excluding the use of polynaphthalene sulfonate dispersants (PNS) and melamine sulfonate dispersants. In embodiments, the slurry exhibits a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the SFS test.

In another aspect, the disclosure provides a method of making gypsum board. The method comprises mixing a slurry comprising stucco, water, and a high-efficiency lignosulfonate dispersant, the slurry substantially excluding a naphthalene sulfonate and melamine sulfonate. In embodiments, the slurry exhibits a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the SFS test. The method also comprises placing the slurry between two cover sheets to form a board precursor. In addition, the method allows the slurry in the precursor to set to form the board. The method involves cutting the board, wherein the board has a nail pull resistance of at least 72 pounds according to ASTM 473-10 and/or a core hardness of at least 11 pounds as determined according to ASTM 473-10, and the board has a density of 55 pcf or less.

In another aspect, the disclosure provides a gypsum board comprising a set gypsum core disposed between two cover sheets. The core is formed from a slurry comprising stucco, water, and a high-efficiency lignosulfonate. The slurry substantially excludes a polynaphthalene sulfonate and melamine sulfonate. The high-efficiency lignosulfonate has a molecular weight of at least 40,000 Da and the slurry has a water/stucco ratio of 1.0 or less (e.g., 0.8 or less, such as 0.3 to 1.0, 0.3 to 0.8, 0.5 to 1.0, 0.5 to 0.85).

In another aspect, the disclosure provides a slurry comprising water, stucco, and a high-efficiency lignosulfonate. The slurry substantially excludes a polynaphthalene sulfonate and melamine sulfonate. The high-efficiency lignosulfonate has a molecular weight of at least 40,000 Da and the slurry has a water/stucco ratio of 1.0 or less (e.g., 0.8 or less, such as 0.3 to 1.0, 0.3 to 0.8, 0.5 to 1.0, 0.5 to 0.85).

In another aspect, the disclosure provides a method of making gypsum board. The method comprises mixing a slurry comprising stucco, water, and a high-efficiency lignosulfonate. The slurry substantially excludes a naphthalene sulfonate and melamine sulfonate. The high-efficiency lignosulfonate has a molecular weight of at least 40,000 Da and the slurry has a water/stucco ratio of 1.0 or less (e.g., 0.8 or less, such as 0.3 to 1.0, 0.3 to 0.8, 0.5 to 1.0, 0.5 to 0.85). The method further comprises placing the slurry between two cover sheets to form a board precursor; allowing the slurry in the precursor to set to form the board; and cutting the board, wherein the board has a nail pull resistance of at least 72 pounds according to ASTM 473-10 and/or a core hardness of at least 11 pounds as determined according to ASTM 473-10.

Further and alternative aspects and features of the disclosed principles will be appreciated from the following detailed description. As will be appreciated, the slurries, boards, and methods disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### DETAILED DESCRIPTION

Embodiments of the disclosure provide a gypsum slurry, a gypsum board, and a method of preparing gypsum board using a high-efficiency lignosulfonate dispersant while excluding a polynaphthalene sulfonate (PNS) or melamine sulfonate dispersant. The gypsum board includes a board core comprising set gypsum sandwiched between face and back cover sheets. The set gypsum core is formed from a core slurry comprising stucco, water, the high-efficiency lignosulfonate dispersant, and optional ingredients as desired, including, for example, but not limited to, foaming agent, accelerator (e.g., heat resistant accelerator), retarder, strength-enhancing starch, migrating starch, polyphosphate, fiber, etc. A dense layer (sometimes referred to as a “skim coat”) can be optionally disposed between the board core and the face cover sheet and/or between the board core and the back cover sheet. In accordance with embodiments of the disclosure, the dense layers are formed from one or more dense layer slurries (which can be the same or different) comprising water, stucco, and optionally the high-efficiency lignosulfonate dispersant and other ingredients as discussed herein. The dense layer generally has a significantly greater density and significantly lower thickness than that of the board core.

The high-efficiency lignosulfonate dispersant is provided to improve the slurry rheology and to reduce the amount of water needed to spread the slurry and form the gypsum board. The dispersant may be included in a dry form or wet form. Generally, such dispersants are effective at reducing the amount of water needed during the wallboard manufacturing process. While not wishing to be bound by any theory, such dispersants are believed to increase the repulsive forces between the gypsum particles, thereby allowing gypsum particles to spread out and flow more freely. Beneficially, when the slurry flows more freely, the amount of water can be reduced and still retain desirable fluidity. A reduction in water may also lead to other benefits, e.g., increased product strength and manufacturing efficiency. Another benefit of dispersants is that they can enhance fluidity sufficient to counteract detrimental effects on water-demand by certain other additives in the gypsum slurry, such as strength-enhancing starch, migrating starch, fiber, etc. Generally, the addition of additives, such as starch, may increase the viscosity of a slurry and reduce the fluidity of the slurry and the high-efficiency lignosulfonates, according to embodiments of the disclosure, compensate for the negative effects on fluidity by such ingredients. Fluidity can be determined, e.g., by use of the SFS test as described herein.

Surprisingly and unexpectedly, embodiments of the disclosure are able to exclude the use of synthetically derived dispersants (such as PNS and/or melamine sulfonate based dispersants). Conventionally, there has been a belief that PNS and/or melamine sulfonate based dispersants are preferred in the art as generally outperforming naturally derived dispersants with respect to, e.g., water-demand, fluidity, and other rheological properties. As an example, PNS-based dispersants, when added, have been conventionally believed to reduce nearly twice the amount of water when compared with compositions formed with the inclusion of naturally-derived dispersants, such as conventional lignosulfonates. As such, PNS-based dispersants are generally the predominant water-reducing agent used in gypsum slurries due to their compatibility with gypsum slurries as well as its favorable cost to water reduction ratios. In this regard, under the same dosage, PNS-based dispersants have been conventionally used to reduce more water than lignosuflonate-based dispersants to further enhance the efficiency of the process.

Surprisingly and unexpectedly, the use of the high-efficiency lignosulfonate dispersant provides good performance (e.g., with respect to fluidity and water-demand) while allowing for the exclusion of certain synthetic dispersants including, for example, polynaphthalene sulfonate and melamine sulfonate. This is advantageous because synthetic dispersants are often formed from chemicals which are associated with detrimental impacts on biological entities and/or environmental processes. For example, conventionally, synthetic dispersants such as PNS and/or melamine sulfonate based dispersants are polymerized with aldehydes (e.g., formaldehyde). Formaldehyde, and other aldehydes are considered to be “red-listed” chemicals for posing certain deleterious health effects as a known carcinogen. In some embodiments, the slurry substantially excludes the inclusion of toxic or red-listed chemicals. In this regard, the Living Building Challenge (LBC) Red List represents materials, chemicals, and elements considered detrimental to biological processes (human health and environmental factors, for example) that are prevalent in the building products industry, as determined by the International Living Future Institute (ILFI).

Advantageously, it has been discovered that, surprisingly and unexpectedly, the high-efficiency lignosulfonate can be used to achieve comparable dispersant qualities as naphthalene sulfonates and melamine sulfonates without the concomitant harmful biological and environmental effects. Thus, in gypsum slurries, gypsum boards, and methods of making gypsum boards according to embodiments of the disclosure, the high-efficiency lignosulfonate dispersant demonstrates comparable slurry fluidities at identical dosages as polynaphthalene sulfonates. In some embodiments, the high-efficiency lignosulfonate dispersant enhances the fluidity of a gypsum slurry to a comparable degree (e.g., equal or greater than) to the fluidity in a gypsum slurry containing the same amount of polynaphthalene sulfonate of the same gypsum slurry absent the high-efficiency lignosulfonate dispersant. In addition, in some embodiments, the high-efficiency lignosulfonate dispersant enhances the water demand of a gypsum slurry to a comparable degree (e.g., equal or less than) to the water demand of the same gypsum slurry containing the same amount of polynaphthalene sulfonate of the same gypsum slurry absent the high-efficiency lignosulfonate dispersant.

The slurry, according to embodiments of the disclosure, comprises water, stucco, and a high-efficiency lignosulfonate dispersant. The slurry substantially excludes polynaphthalene sulfonate and melamine sulfonate. In an aspect, high-efficiency for the lignosulfonate refers to the dosage needed to achieve a sufficient gypsum slurry fluidity and is determined by testing the gypsum slurry flowability at different dosages until a desired spread is achieved such that the lignosulfonate demonstrates comparable slurry fluidities at identical dosages as polynaphthalene sulfonates. In embodiments, the slurry exhibits a slump according to the slump test as referred to herein that is within 10% of the slump produced by an otherwise identical slurry containing the polynaphthalene sulfonate instead of the high-efficiency lignosulfonate wherein the active content of the high-efficiency lignosulfonate is the same as the polynaphthalene sulfonate.

The gypsum board, according to embodiments of the disclosure, comprises a set gypsum core disposed between two cover sheets. The gypsum core is formed from a slurry comprising stucco, water, and a high-efficiency lignosulfonate. The core slurry substantially excludes a polynaphthalene sulfonate and melamine sulfonate. In embodiments, the slurry exhibits a slump according to the slump test as referred to herein that is within 10% of the slump produced by an otherwise identical slurry containing the polynaphthalene sulfonate instead of the high-efficiency lignosulfonate wherein the active content of the high-efficiency lignosulfonate is the same as the polynaphthalene sulfonate.

The method of making board, in accordance with embodiments of the disclosure, comprises mixing a slurry comprising stucco, water, and a high-efficiency lignosulfonate dispersant, the slurry substantially excluding a naphthalene sulfonate and melamine sulfonate. In some embodiments, high-efficiency is a measurement of dosage needed to achieve a sufficient gypsum slurry fluidity and is determined by testing the gypsum slurry flowability at different dosages until a desired spread is achieved such that the lignosulfonate demonstrates comparable slurry fluidities at identical dosages as polynaphthalene sulfonates. In embodiments, the slurry exhibits a patty according to the SFS test as referred to herein that is within 10% of the patty produced by an otherwise identical slurry containing the polynaphthalene sulfonate instead of the high-efficiency lignosulfonate wherein the active content of the high-efficiency lignosulfonate is the same as the polynaphthalene sulfonate. The method also comprises placing the slurry between two cover sheets to form a board precursor. In addition, the method allows the slurry in the precursor to set to form the board. The method involves cutting the board, wherein the board has a nail pull resistance of at least 72 pounds according to ASTM 473-10 and/or a core hardness of at least 11 pounds as determined according to ASTM 473-10, and the board has a density of 55 pcf or less.

The slurry for forming the core contains water, stucco, high-efficiency lignosulfonate dispersant, and optional ingredients such as foaming agent, accelerator, retarder, strength-enhancing starch, migrating starch, and other components as desired.

Stucco is sometimes referred to as calcined gypsum, and it can be in the form of calcium sulfate alpha hemihydrate, calcium sulfate beta hemihydrate, and/or calcium sulfate anhydrite. The calcined gypsum can be fibrous in some embodiments, nonfibrous in other embodiments, or a combination thereof in other embodiments. In embodiments, the calcined gypsum can include at least 50% beta calcium sulfate hemihydrate. In other embodiments, the calcined gypsum can include at least 86% beta calcium sulfate hemihydrate.

The weight ratio of water to calcined gypsum can be any suitable ratio, although, as one of ordinary skill in the art will appreciate, lower ratios can be more efficient because less excess water will remain after the hydration process of the stucco is completed during manufacture, thereby conserving energy. In this regard, the high-efficiency lignosulfonate dispersant can be provided in an amount effective to achieve desired lower water/stucco ratios, e.g., 0.95 or less, such as 0.85 or less or 0.8 or less. In some embodiments, the cementitious slurry can be prepared by combining water and calcined gypsum in a suitable water to stucco weight ratio for board production depending on products, such as in a range between 0.3 and 2. For example, the core slurry formulations can be made with any suitable water/stucco ratio, e.g., 0.6 to 2, 0.6 to 1.5, 0.6 to 1, 0.6 to 0.9, 0.6 to 0.85, 0.6 to 0.8, 0.6 to 0.75, 0.6 to 0.7. 0.6 to 0.65, 0.5 to 2, 0.5 to 1.5, 0.5 to 1, 0.5 to 0.9, 0.5 to 0.85, 0.5 to 0.8, 0.5 to 0.75, 0.5 to 0.7. 0.5 to 0.65, 0.4 to 2, 0.4 to 1.5, 0.4 to 1, 0.4 to 0.9, 0.4 to 0.85, 0.4 to 0.8, 0.4 to 0.75, 0.4 to 0.7. 0.4 to 0.65, 0.3 to 2, 0.3 to 1.5, 0.3 to 1, 0.3 to 0.9, 0.3 to 0.85, 0.3 to 0.8, 0.3 to 7.5, 0.3 to 0.7, 0.3 to 0.65, 0.3 to 0.5, 0.4 to 0.6, etc.

The slurry further contains the dispersant comprising high-efficiency lignosulfonate and excluding polynaphthalene sulfonate and melamine sulfonate. According to embodiments of the disclosure, it has been discovered that, surprisingly and unexpectedly, certain lignosulfonates, referred to herein as “high-efficiency lignosulfonates,” can be used with good fluidity and water-demand performance.

Lignosulfonates are often prepared as a mixture containing a wide range of molecular weights. In some embodiments, the high-efficiency lignosulfonate dispersant can be prepared by removing lower molecular weight lignosulfonate from the mixture, e.g., by filtration, particularly ultrafiltration. The ultrafiltration (sometimes referred to as “UF”) process may generally consist of a variety of membrane filtration methods in which forces such as pressure or concentration gradients lead to a separation through a semipermeable membrane. Water and low molecular weight solutes, for example, may pass through the membrane in the permeate, while suspended solids and solutes of high molecular weight may be retained in the retentate.

For example, in some embodiments, to achieve high-efficiency lignosulfonate, ultrafiltration can be used to remove lower molecular weight molecules. In some embodiments, the molecular weight of the high-efficiency lignosuflonate resulting from the ultrafiltration process may remove lignosulfonates having a molecular weight of 40 kDa or less; e.g., such as less than 30 kDa; less than 20 kDa; less than 10 kDa; etc.

The lignosulfonate anion moiety of the metal lignosulfonate salt is generally a product of the sulfonation of lignin. The anion may comprise polymeric molecules of weight-average molecular weight of at least 20,000 g/mol (Daltons or “Da”), e.g., at least 30,000, 40,000, 50,000, 60,000. In some embodiments, the high-efficiency lignosulfonate dispersant can have a molecular weight of from 20,000 to 100,000, e.g., from 20,000 Da to 90,000 Da; from 20,000 Da to 80,000 Da; from 20,000 Da to 70,000 Da; from 20,000 Da to 60,000 Da; from 20,000 Da to 50,000 Da; from 20,000 Da to 40,000 Da; from 20,000 Da to 30,000 Da; from 30,000 Da to 100,000 Da; from 30,000 Da to 90,000 Da; from 30,000 Da to 80,000 Da; from 30,000 Da to 70,000 Da; from 30,000 Da to 60,000 Da; from 30,000 Da to 50,000 Da; from 30,000 Da to 40,000 Da; from 40,000 Da to 100,000 Da; from 40,000 Da to 90,000 Da; from 40,000 Da to 80,000 Da; from 40,000 Da to 70,000 Da; from 40,000 Da to 60,000 Da; from 40,000 Da to 50,000 Da; from 50,000 Da to 100,000 Da; from 50,000 Da to 90,000 Da; from 50,000 Da to 80,000 Da; from 50,000 Da to 70,000 Da; from 50,000 Da to 60,000 Da; from 60,000 Da to 100,000 Da; from 60,000 Da to 90,000 Da; from 60,000 Da to 80,000 Da; from 60,000 Da to 70,000 Da; from 70,000 Da to 100,000 Da; from 70,000 Da to 90,000 Da; from 70,000 Da to 80,000 Da; from 80,000 Da to 100,000 Da; from 80,000 Da to 90,000 Da; and from 90,000 Da to 100,000 Da.

The high-efficiency lignosulfonate can be added to the gypsum slurry in dry (e.g., powder) or wet (e.g., suspended or dissolved in a liquid medium) form(s). In wet form (diluted), the active content of the high-efficiency lignosulfonate can be any suitable amount. For example, in some embodiments, the active content is 60% or less, e.g., 25%-50%, 25%-45%, 30%-40%, etc. It will be understood that efficiency of the lignosulfonate is determined by normalizing the amount to the active content (e.g., when comparing a dry, i.e., 100%, form as compared with a wet, diluted form where the active content will be less than 100%). In embodiments, high-efficiency lignosulfonate dispersants provide at least 50% higher efficiency compared to other normal or regular lignosulfonate dispersants (e.g., 2×, 2.5×, 3×, etc.) with respect to water-demand.

The pH of the dispersant solution when added into the gypsum slurry can be any suitable value. For example, in some embodiments, the dispersant solution can be added into the gypsum slurry at a pH value in water in a range from 7.0 to 11.0. For example, the high-efficiency lignosulfonate dispersant may have a pH value in a range from, e.g., 7.0 to 10.5; 8.0 to 10.0; 7.3 to 11; 9.3 to 10.5; 8.3 to 10.0; 9.5 to 11.0; 7.5 to 10.5; 9.5 to 10.0; 8.6 to 11.0; 9.7 to 11.0; 7.8 to 11.0; 9.9 to 11.0; 10.0 to 11.0; 10.5 to 11.0; etc. In some embodiments, the pH value is in a range from 9.5 to 10.3 In some embodiments, the high-efficiency lignosulfonate dispersant has a specific gravity in a range of 1.0 g/cm³ to 2.5 g/cm³. For example, the high-efficiency lignosulfonate dispersant may have a specific gravity in a range from, e.g., 1.0 g/cm³ to 2.4 g/cm³; 1.0 g/cm³ to 2.3 g/cm³; 1.0 g/cm³ to 2.2 g/cm³; 1.0 g/cm³ to 2.1 g/cm³; 1.0 g/cm³ to 2.0 g/cm³; 1.1 g/cm³ to 2.5 g/cm³; 1.2 g/cm³ to 2.5 g/cm³; 1.3 g/cm³ to 2.5 g/cm³; 1.4 g/cm³ to 2.5 g/cm³; 1.5 g/cm³ to 2.5 g/cm³; etc. In some embodiments, the specific gravity is 1.32 g/cm³.

In some embodiments, the high-efficiency lignosulfonate is provided in an amount of from 0.01% to 5% by weight of the stucco, e.g., from 0.05% to 3%, or from 0.1% to 2%. In some embodiments, the high-efficiency lignosulfonate is added to the slurry in a solution containing less than 60% lignosulfonate, e.g., from 30% to 50% lignosulfonate, such as from 25% to 45% lignosulfonate. The slurry desirably excludes any components containing formaldehyde or other aldehydes and/or excludes components polymerized in the presence of formaldehyde or other aldehydes. Preferably, the high-efficiency lignosulfonate is not polymerized by the use of an aldehyde such as formaldehyde.

An example of a high-efficiency lignosulfonate dispersant may include, inter alia, Ultrazine® NA sodium lignosulfonate dispersant and Ultrazine® CA calcium lignosulfonate dispersant; all of which are available from the Borregaard® Lignotech Company, headquartered in Sarpsborg, Norway.

In some embodiments, the high-efficiency lignosulfonate dispersant includes Ultrazine® NA sodium lignosulfonate. In some embodiments, the high-efficiency lignosulfonate dispersant is present in the form of an ultrafine powder. In embodiments, the high-efficiency lignosulfonate dispersant has a pH value in water in a range from 7.0 to 11.0 (e.g., 7 to 9.5). In embodiments, the high-efficiency lignosulfonate dispersant has a specific gravity in a range of 1.0 g/cm³ to 2.5 g/cm³ (e.g., 1.32 g/cm³).

In some embodiments, the high-efficiency lignosulfonate dispersant includes Ultrazine® CA calcium lignosulfonate dispersant. In some embodiments, the high-efficiency lignosulfonate dispersant is present in the form of an ultrafine powder. In embodiments, the high-efficiency lignosulfonate dispersant has a pH value in water in a range from 7.0 to 11.0 (e.g., 7 to 9.5). In embodiments, the high-efficiency lignosulfonate dispersant has a specific gravity in a range of 1.0 g/cm³ to 2.5 g/cm³ (e.g., 1.32 g/cm³).

In embodiments, high-efficiency lignosulfonates exclude one or more of the following types of lignin-based dispersants: mono-calcium salt of polymerized aryl alkylsulfonic acids (lignosulfonate calcium salt); sodium salt of kraft lignin polymer optionally mixed with a modified sulfite lignin; ammonium lignosulfonates; lignin, alkali, and reaction product with sodium bisulfite and formaldehyde. Metal lignosulfonate salts can be prepared from the waste liquor of sulfite pulping which are then further oxidized, or desulfonated. Conventionally used examples of lignosulfonate-based dispersants that are not high-efficiency lignosulfonates are Marasperse C-21, available in powder form from Reed Lignin Inc., and Marasperse GNS, available in liquid form from Borregaard® Lignotech Company, headquartered in Sarpsborg, Norway.

In some embodiments, the high-efficiency lignosulfonate is characterized by providing and/or enhancing the fluidity of a gypsum slurry comparable (e.g., equal or greater than) to the fluidity of the same gypsum slurry absent the high-efficiency lignosulfonate but containing the same dosage of PNS or melamine sulfonate instead. In some embodiments, the high-efficiency lignosulfonate is characterized by providing a water demand comparable (e.g., equal or less than) to the water demand of the same slurry absent the high-efficiency lignosulfonate but containing the same amount of PNS or melamine sulfonate instead.

According to embodiments of the disclosure, it has been discovered that, surprisingly and unexpectedly, compositions (and respective methods) using a high-efficiency lignosulfonate dispersant achieves high water reduction, low retardation, and may perform equal or better than the use of synthetic dispersants (e.g., PNS-based dispersants). Among other things, such a high-efficiency lignosulfonate dispersant may achieve comparable results to synthetic dispersants (e.g., PNS-based dispersants) with respect to, for example, water demand, while not including potentially harmful or otherwise undesired red-listed chemicals. In accordance to aspects of the invention, the high-efficiency lignosulfonate dispersant is non-toxic, non-corrosive, and biodegradable. The inventors have discovered that, surprisingly and unexpectedly, the use of a high-efficiency lignosulfonate dispersant achieve high water reduction, low retardation, and are, surprisingly and unexpectedly, suitable alternatives to, for example, synthetic polymers like PNS-based dispersants.

In some embodiments, the high-efficiency lignosulfonate reduces the water demand of the gypsum slurry by at least 2% (e.g. 2% to 20%; 2% to 15%; 2% to 10%; 2% to 5%; 3% to 20%; 3% to 15%; 3% to 10%; 3% to 5%; 4% to 20%; 4% to 15%; 4% to 10%; 4% to 5%; 5% to 20%; 5% to 15%; 5% to 10%) as measured by the SFS test as described herein as compared with standard lignosulfonate dispersants at the same solid content dosage and measured by the same method.

Foaming agent can also be included in the core slurry. The foaming agent can be added by addition in a primary discharge conduit of the main board mixer. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness can be effective to enhance strength, especially in lower density board (e.g., 35 pcf or less). See, e.g., U.S. Pat. Nos. 9,802,866 and 9,840,066. Evaporative water voids, generally having voids of 5 μm or less in diameter, also contribute to the total void distribution along with the aforementioned air (foam) voids.

The strength-enhancing starch refers to a starch that improves the strength of the board (e.g., with respect to nail pull strength) as compared with the same board excluding the starch. Starches for strength enhancement are discussed in, e.g., U.S. Pat. Nos. 9,540,810, 9,828,441, 10,399,899, and 10,919,808. Any suitable strength-enhancing starch can be used, including hydroxyalkylated starches such as hydroxyethylated or hydroxypropylated starch, or a combination thereof; a pregelatinized starch; or an uncooked, non-migrating, starch.

Any suitable pregelatinized starch can be included in the core slurry, as described in U.S. Pat. Nos. 10,399,899 and 9,828,441, including methods of preparation thereof and desired viscosity ranges described therein. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In other embodiments, the pregelatinized starch has a greater viscosity, such as greater than 700 centipoise (e.g., 773 centipoise) according to the VMA test.

In some embodiments, the starch includes an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute as described in U.S. Pat. No. 10,919,808.

For example, in some embodiments, the strength-enhancing starch includes an uncooked medium hydrolyzed acid modified starch (e.g., an uncooked acid-modified corn starch having a hot water viscosity of 180 BU); and/or a medium viscosity and medium molecular weight pregelatinized starch (e.g., pregelatinized corn flour starch with a cold water viscosity of 90 centipoise).

Strength-enhancing starches differ from migrating starches such as LC-211, commercially available from Archer-Daniels-Midland, Chicago, Illinois. Migrating starches normally have smaller chain lengths (e.g., due to acid- or enzyme-modification) and migrate to the core-cover sheet interface for further bond enhancement. For example, in some embodiments, the core slurry includes a migrating starch having a molecular weight of 6,000 Daltons or less.

If included, the optional strength-enhancing starch can be included in the core slurry in any suitable amount. For example, in some embodiments, the core slurry comprises a strength-enhancing starch in an amount of at least 0.5% by weight of the stucco (e.g., from 0.5% to 5% by weight of the stucco, such as from 0.5% to 3%, from 1% to 5%, from 1% to 3%, from 2% to 5%, from 2% to 4%, from 2% to 3%, by weight of the stucco, etc.). In some embodiments, the core slurry is substantially free of a strength-enhancing starch, e.g., having 2% or less by weight of stucco, such as 1% or less by weight of the stucco.

Other additives can be included in the core slurry. Such additives include structural additives, including mineral wool, perlite, clay, calcium carbonate, and chemical additives, including fillers, sugar, enhancing agents (such as phosphonates, borates and the like), binders (such as latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Pat. Nos. 7,244,304; 7,364,015; 7,803,226; 7,892,472; 6,342,284; 6,632,550; 6,800,131; 5,643,510; 5,714,001; and 6,774,146; and U.S. Patent Application Publication 2002/0045074. Other examples of such additives include fire-rated and/or water resistant product that can also optionally be included in the core slurry, include e.g., siloxanes (water resistance); heat sink additives such as aluminum trihydrite (ATH), magnesium hydroxide or the like; and/or high expansion particles (e.g., expandable to 300% or more of original volume when heated for about one hour at 1560° F.). See, e.g., U.S. Pat. No. 8,323,785 for description of these and other ingredients. In some embodiments, high expansion vermiculite is included, although other fire resistant materials can be included.

The core slurry can include accelerator and/or retarder. Accelerator (e.g., wet gypsum accelerator, heat resistant accelerator, climate stabilized accelerator) and retarder are well known and can be included in the core slurry, if desired. See, e.g., U.S. Pat. Nos. 3,573,947 and 6,409,825. In some embodiments where accelerator and/or retarder are included, the accelerator and/or retarder each can be in the core slurry in an amount on a solid basis of, such as, from 0% to 10% by weight of the stucco (e.g., 0.1% to 10%), such as, for example, from 0% to 5% by weight of the stucco (e.g., 0.1% to 5%).

Polyphosphate can optionally be included in the core slurry, e.g., in order to enhance sag resistance in the board. Trimetaphosphate compounds can be used, including, for example, sodium trimetaphosphate, potassium trimetaphosphate, lithium trimetaphosphate, and ammonium trimetaphosphate.

With respect to the polyphosphate (e.g., sodium trimetaphosphate), the core slurry can include it in any suitable amount, e.g., from 0.01% to 0.5% by weight of the stucco, from 0.01% to 0.4%, from 0.05% to 0.3%, from 0.1% to 0.5%, from 0.1% to 0.4%, from 0.1% to 0.3%, from 0.1% to 0.2%, from 0.15% to 0.5%, from 0.2% to 0.4%, from 0.05% to 0.5%, by weight of the stucco, etc.

With respect to the cover sheets, they can be formed of any suitable material and basis weight. For example, some embodiments of the disclosure allow for good board strength even with the use of lower basis weight cover sheets such as, for example, less than 45 lbs/MSF (e.g., 33 lbs/MSF to 45 lbs/MSF) even for lower weight board (e.g., having a density of 35 pcf or below). However, if desired, in some embodiments, heavier basis weights can be used, e.g., to further enhance nail pull resistance or to enhance handling, e.g., to facilitate desirable “feel” characteristics for end-users. In some embodiments, to enhance strength (e.g., nail pull strength), especially for lower density board, one or both of the cover sheets can be formed from paper and have a basis weight of, for example, at least 45 lbs/MSF (e.g., from 45 lbs/MSF to 65 lbs/MSF, 45 lbs/MSF to 60 lbs/MSF, 45 lbs/MSF to 55 lbs/MSF, 50 lbs/MSF to 65 lbs/MSF, 50 lbs/MSF to 60 lbs/MSF, etc.). If desired, in some embodiments, one cover sheet (e.g., the “face” paper side when installed) can have aforementioned greater basis weight, e.g., to enhance nail pull resistance and handling, while the other cover sheet (e.g., the “back” sheet when the board is installed) can have somewhat lower weight basis if desired (e.g., weight basis of less than 45 lbs/MSF, e.g., from 33 lbs/MSF to 45 lbs/MSF (e.g., 33 lbs/MSF to 40 lbs/MSF).

In accordance with embodiments of the disclosure, the gypsum board includes a board core comprising set gypsum sandwiched between face and back cover sheets with a dense layer disposed between the board core and the face cover sheet.

In some embodiments, board according to the invention meets test protocols according to ASTM Standard C473-10. For example, in some embodiments, when the board is cast at a thickness of ½ inch, the board has a nail pull resistance of at least 65 lb as determined according to ASTM C 473 (e.g., at least 68 lb, at least 70 lb, at least 72 lb, at least 75 lb, at least 77 lb, etc). With respect to flexural strength, in some embodiments, when cast in a board of ½ inch thickness, the board has a flexural strength of at least 36 lb in a machine direction (e.g., at least 38 lb, at least 40 lb, etc) and/or at least 107 lb (e.g., at least 110 lb, at least 112 lb, etc) in a cross-machine direction as determined according to the ASTM standard C473. In addition, in some embodiments, board can have an average core hardness of at least 11 pounds as determined according to ASTM C-473. Due at least in part to the mid-range viscosity characteristic of embodiments of the invention, these standards can be met even with respect to lower density board (e.g., 35 pcf or less) as described herein.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets may vary slightly as well understood in the art.

Board weight is a function of thickness. Since boards are commonly made at varying thickness, board density is used herein as a measure of board weight. The advantages of the use of the high-efficiency lignosulfonate dispersant in accordance with embodiments of the disclosure can be seen across various board densities, e.g., 55 pcf or less, such as from 10 pcf to 55 pcf, from 12 pcf to 55 pcf, from 10 pcf to 40 pcf, from 12 pcf to 40 pcf, from 16 pcf to 35 pcf, from 20 pcf to 40 pcf, from 24 pcf to 37 pcf, etc. However, some embodiments have particular utility at lower densities, e.g. from 12 pcf to 35 pcf, from 12 pcf to 30 pcf, from 12 pcf to 27 pcf, from 16 pcf to 30 pcf, from 16 pcf to 27 pcf, from 16 pcf to 24 pcf, from 18 pcf to 30 pcf, from 18 pcf to 27 pcf, from 20 pcf to 30 pcf, from 20 pcf to 27 pcf, from 24 pcf to 35 pcf, from 27 pcf to 35 pcf, from 27 pcf to 34 pcf, from 27 pcf to 30 pcf, from 30 pcf to 34 pcf, etc. The dense layer has a considerably greater density than the density of the board core. For example, the dense layer can have a density of from 40 pcf to 70 pcf (e.g., from 45 pcf to 65 pcf, or from 50 pcf to 60 pcf).

The core can have any suitable density but lower densities can be used, e.g., a core density of 35 pcf or less (e.g., 31 pcf or less, or 27 pcf or less). For example, the core can have a density of from 15 pcf to 35 pcf (e.g., from 20 pcf to 31 pcf, from 20 pcf to 24 pcf, or from 24 pcf to 27 pcf, etc.).

The board can be prepared in any suitable manner. In embodiments, a main mixer containing an agitator as understood in the art is used at a wet end of a manufacturing line as also understood in the art. The agitator can be in the form of pins, disk, impeller, propeller, rotor spinning inside a stationary housing, or the like. The main mixer can be used to prepare a core and dense slurry, respectively. Stucco, water, and optionally, an additive package are inserted into the main mixer. The mixer contains a primary discharge conduit and a secondary discharge conduit. Slurry is discharged from the primary discharge conduit where core additives such as foam (see, e.g., U.S. Pat. No. 5,683,635) are inserted to form a core slurry. Slurry can be released from the secondary discharge conduit to form a dense layer slurry (e.g., with less or no foaming agent as compared with the core slurry).

A first moving cover sheet (e.g., over a moving conveyor) is provided. The board is generally formed upside down at the wet end of the plant such that the first moving cover sheet is generally the face cover sheet, although this is not mandatory. The dense layer slurry is deposited over the moving cover sheet. The core slurry is deposited over the dense layer. A second moving cover sheet (e.g., the back paper) is applied over the core slurry layer to form a sandwich structure of a board precursor. In embodiments, the dense layer slurry is deposited onto the moving cover sheet upstream of the mixer, while the core slurry is deposited over the cover sheet bearing the dense layer, downstream of the mixer. In some embodiments, the secondary discharge conduit is disposed on the mixer upstream of the primary discharge conduit to conveniently accommodate this arrangement of depositing the layers relative to the positioning of the mixer.

If desired, it will be understood that the board can be prepared using two separate mixers equipped with agitators, with one mixer dedicated for preparing the core slurry and the other mixer dedicated for preparing the core slurry. As such, each of the dense layer and core slurries can be separately formulated and discharged out of each mixer and then applied to form the board as described herein.

After the sandwich structure of the board precursor is formed at the wet end of the manufacturing line, the board precursor sets as it travels, e.g., by conveyor, to other stations, including a knife, where the board precursor is cut into segments. The board can then be flipped and dried in a kiln to form the final board product and processed at the dry end of the manufacturing line, e.g., to a final size, as understood by one of ordinary skill in the art. Arrangements for producing the board are described in, e.g., U.S. Pat. Nos. 5,683,635; 6,494,609; 6,874,930; and 7,364,676 and U.S. Patent Application Publications 2010/0247937; 2012/0168527; and 2012/0170403.

### Aspects

The disclosure is further illustrated by the following exemplary aspects. However, the disclosure is not limited by the following aspects.

(1) A gypsum board, slurry, or method of preparing board, as described herein.

(2) A gypsum board comprising: a set gypsum core disposed between two cover sheets, the core formed from a slurry comprising stucco, water, and a high-efficiency lignosulfonate, the slurry substantially excluding a polynaphthalene sulfonate and melamine sulfonate; the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the slump fluidity spread (SFS) test.

(3) The gypsum board of aspect 2, wherein the lignosulfonate has a molecular weight of at least 20,000 Da.

(4) The gypsum board of aspect 2, wherein the lignosulfonate has a molecular weight of at least 40,000 Da.

(5) The gypsum board of aspect 2, wherein slurry forms a patty of at least 6.5 inches when measured in accordance with the SFS test.

(6) The gypsum board of any one of aspects 2-5, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

(7) The gypsum board of any one of aspects 2-6, wherein the slurry has a water/stucco ratio of from 0.3 to 1.00, such as from 0.3 to 0.95, or from 0.3 to 0.9.

(8) The gypsum board of any one of aspects 2-7, wherein the slurry has a water/stucco ratio of less than 0.85, e.g., such as from 0.3 to 0.85.

(9) The gypsum board of any one of aspects 2-8, wherein the slurry has a water/stucco ratio of less than 0.8, such as less than 0.75, e.g., from 0.3 to 0.8, or from 0.3 to 0.75.

(10) The gypsum board of any one of aspects 2-9, wherein the lignosulfonate is provided in an amount of from 0.01% to 5% by weight of the stucco, e.g., from 0.05% to 3%, or from 0.1% to 2%.

(11) The gypsum board of any one of aspects 2-10, wherein the lignosulfonate is added to the slurry in a solution containing less than 60% lignosulfonate, e.g., from 30% to 50% lignosulfonate, such as from 25% to 45% lignosulfonate.

(12) The gypsum board of any one of aspects 2-11, wherein the slurry excludes any components containing formaldehyde or other aldehyde, or polymerized in the presence of formaldehyde or other aldehyde.

(13) The gypsum board of any one of aspects 2-12, wherein the lignosulfonate is not polymerized by an aldehyde such as formaldehyde.

(14) The gypsum board of any one of aspects 2-13, wherein the board has a nail pull resistance of at least 72 pounds according to ASTM 473-10 and/or a core hardness of at least 11 pounds. as determined according to ASTM 473-10.

(15) The gypsum board of any one of aspects 2-14, the slurry requiring an increase in water demand to maintain the slurry fluidity at the same or lower level that it would be without the high-efficiency lignosulfonate in an otherwise identical slurry containing a polynaphthalene sulfonate instead of the high-efficiency lignosulfonate.

(16) The gypsum board of any one of aspects 2-15, wherein the dense layers are formed from one or more dense layer slurries comprising water, stucco, and optionally the high-efficiency lignosulfonate dispersant.

(17) A slurry comprising water, stucco, and a high-efficiency lignosulfonate, the slurry substantially excluding a polynaphthalene sulfonate and melamine sulfonate; the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the SFS test.

(18) The slurry of aspect 17, wherein the slurry has a water/stucco ratio of from 0.3 to 0.8, such as less than 0.75, e.g., from 0.3 to 0.75.

(19) The slurry of aspects 17 or 18, wherein the lignosulfonate has a molecular weight of at least 20,000 Da.

(20) The slurry of any one of aspects 17-19, wherein the lignosulfonate has a molecular weight of at least 40,000 Da.

(21) The slurry of any one of aspects 17-20, wherein slurry forms a patty of at least 6.5 inches when measured in accordance with the SFS test.

(22) The slurry of any one of aspects 17-21, wherein the lignosulfonate is provided in an amount of from 0.01% to 5% by weight of the stucco, e.g., from 0.05% to 3%, or from 0.1% to 2%.

(23) The slurry of any one of aspects 17-22, wherein the lignosulfonate is added to the slurry in a solution containing less than 60% lignosulfonate, e.g., from 30% to 60% lignosulfonate, such as from 25% to 45% lignosulfonate.

(24) The slurry of any one of aspects 17-23, wherein the lignosulfonate is not polymerized by an aldehyde such as formaldehyde.

(25) The slurry of any one of aspects 17-24, wherein the slurry has a water/stucco ratio of less than 0.8.

(26) The slurry of any one of aspects 17-25, wherein the slurry has a water/stucco ratio of less than 0.75.

(27) A method of making gypsum board, the method comprising: mixing a slurry comprising stucco, water, and a high-efficiency lignosulfonate, the slurry substantially excluding a naphthalene sulfonate and melamine sulfonate, the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the slump fluidity spread (SFS) test; placing the slurry between two cover sheets to form a board precursor; allowing the slurry in the precursor to set to form the board; and cutting the board, wherein the board has a nail pull resistance of at least 72 pounds according to ASTM 473-10 and/or a core hardness of at least 11 pounds as determined according to ASTM 473-10.

(28) The method of aspect 27, wherein the lignosulfonate has a molecular weight of at least 20,000 Da.

(29) The method of aspects 27 or 28, wherein the lignosulfonate has a molecular weight of at least 40,000 Da.

(30) The method of any one of aspects 27-29, wherein slurry forms a patty of at least 6.5 inches when measured in accordance with the SFS test.

(31) The method of any one of aspects 27-30, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

(32) The method of any one of aspects 27-31, wherein the lignosulfonate is added to the slurry in a solution containing less than 60% lignosulfonate, e.g., from 30% to 50% lignosulfonate, such as from 25% to 45% lignosulfonate.

(33) The method of any one of aspects 27-32, wherein the slurry has a water/stucco ratio of from 0.3 to 0.8, such as less than 0.75, e.g., from 0.3 to 0.75.

(34) The method of any one of aspects 27-33, wherein the slurry has a water/stucco ratio of less than 0.8.

(35) The method of any one of aspects 27-34, wherein the slurry has a water/stucco ratio of less than 0.75.

(36) A gypsum board comprising: a set gypsum core disposed between two cover sheets, the core formed from a slurry comprising stucco, water, and a high-efficiency lignosulfonate, the slurry substantially excluding a polynaphthalene sulfonate and melamine sulfonate; wherein the high-efficiency lignosulfonate has a molecular weight of at least 40,000 Da; and wherein the slurry has a water/stucco ratio of 1.0 or less (e.g., 0.8 or less, such as 0.3 to 1.0, 0.3 to 0.8, 0.5 to 1.0, 0.5 to 0.85).

(37) The gypsum board of aspect 36, wherein the slurry forms a patty of at least 6 inches when measured in accordance with the SFS test.

(38) The gypsum board of aspects 36 or 37, wherein the slurry forms a patty of at least 4 inches when measured in accordance with the SFS test.

(39) The gypsum board of any one of aspects 36-38, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

(40) The gypsum board of any one of aspects 36-39, wherein the lignosulfonate is provided in an amount of from 0.01% to 5% by weight of the stucco, e.g., from 0.05% to 3%, or from 0.1% to 2%.

(41) The gypsum board of any one of aspects 36-40, wherein the lignosulfonate is added to the slurry in a solution containing less than 60% lignosulfonate, e.g., from 30% to 50% lignosulfonate, such as from 25% to 45% lignosulfonate.

(42) The gypsum board of any one of aspects 36-41, wherein the slurry excludes any components containing formaldehyde or other aldehyde, or polymerized in the presence of formaldehyde or other aldehyde.

(43) The gypsum board of any one of aspects 36-42, wherein the lignosulfonate is not polymerized by an aldehyde such as formaldehyde.

(44) The gypsum board of any one of aspects 36-43, wherein the board has a nail pull resistance of at least 72 pounds according to ASTM 473-10 and/or a core hardness of at least 11 pounds. as determined according to ASTM 473-10.

(45) The gypsum board of any one of aspects 36-44, the slurry requiring an increase in water demand to maintain the slurry fluidity at the same or lower level that it would be without the high-efficiency lignosulfonate in an otherwise identical slurry containing a polynaphthalene sulfonate instead of the high-efficiency lignosulfonate.

(46) The gypsum board of any one of aspects 36-45, wherein the dense layers are formed from one or more dense layer slurries comprising water, stucco, and optionally the high-efficiency lignosulfonate dispersant.

(47) A slurry comprising water, stucco, and a high-efficiency lignosulfonate, the slurry substantially excluding a polynaphthalene sulfonate and melamine sulfonate; wherein the high-efficiency lignosulfonate has a molecular weight of at least 40,000 Da; and wherein the slurry has a water/stucco ratio of 1.0 or less (e.g., 0.8 or less, such as 0.3 to 1.0, 0.3 to 0.8, 0.5 to 1.0, 0.5 to 0.85).

(48) The slurry of aspect 47, wherein the slurry forms a patty of at least 6 inches when measured in accordance with the SFS test.

(49) The slurry of aspects 47 or 48, wherein the slurry forms a patty of at least 4 inches when measured in accordance with the SFS test.

(50) The slurry of any one of aspects 47-49, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

(51) The slurry of any one of aspects 47-50, wherein the lignosulfonate is provided in an amount of from 0.01% to 5% by weight of the stucco, e.g., from 0.05% to 3%, or from 0.1% to 2%.

(52) The slurry of any one of aspects 47-51, wherein the lignosulfonate is added to the slurry in a solution containing less than 60% lignosulfonate, e.g., from 30% to 50% lignosulfonate, such as from 25% to 45% lignosulfonate.

(53) The slurry of any one of aspects 47-52, wherein the slurry excludes any components containing formaldehyde or other aldehyde, or polymerized in the presence of formaldehyde or other aldehyde.

(54) The slurry of any one of aspects 47-53, wherein the lignosulfonate is not polymerized by an aldehyde such as formaldehyde.

(55) The slurry of any one of aspects 47-54, wherein the board has a nail pull resistance of at least 72 pounds according to ASTM 473-10 and/or a core hardness of at least 11 pounds. as determined according to ASTM 473-10.

(56) The slurry of any one of aspects 47-55, the slurry requiring an increase in water demand to maintain the slurry fluidity at the same or lower level that it would be without the high-efficiency lignosulfonate in an otherwise identical slurry containing a polynaphthalene sulfonate instead of the high-efficiency lignosulfonate.

(57) A method of making gypsum board, the method comprising: mixing a slurry comprising stucco, water, and a high-efficiency lignosulfonate, the slurry substantially excluding a naphthalene sulfonate and melamine sulfonate; wherein the high-efficiency lignosulfonate has a molecular weight of at least 40,000 Da; and wherein the slurry has a water/stucco ratio of 1.0 or less (e.g., 0.8 or less, such as 0.3 to 1.0, 0.3 to 0.8, 0.5 to 1.0, 0.5 to 0.85); placing the slurry between two cover sheets to form a board precursor; allowing the slurry in the precursor to set to form the board; and cutting the board, wherein the board has a nail pull resistance of at least 72 pounds according to ASTM 473-10 and/or a core hardness of at least 11 pounds as determined according to ASTM 473-10.

(58) The method of aspect 57, wherein the slurry forms a patty of at least 6 inches when measured in accordance with the SFS test.

(59) The method of aspects 57 or 58, wherein the slurry forms a patty of at least 4 inches when measured in accordance with the SFS test.

(60) The method of any one of aspects 57-59, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

(61) The method of any one of aspects 57-60, wherein the lignosulfonate is provided in an amount of from 0.01% to 5% by weight of the stucco, e.g., from 0.05% to 3%, or from 0.1% to 2%.

(62) The method of any one of aspects 57-61, wherein the lignosulfonate is added to the slurry in a solution containing less than 60% lignosulfonate, e.g., from 30% to 50% lignosulfonate, such as from 25% to 45% lignosulfonate.

(63) The method of any one of aspects 57-62, wherein the slurry excludes any components containing formaldehyde or other aldehyde, or polymerized in the presence of formaldehyde or other aldehyde.

(64) The method of any one of aspects 57-63, wherein the lignosulfonate is not polymerized by an aldehyde such as formaldehyde.

(65) The method of any one of aspects 57-64, wherein the board has a nail pull resistance of at least 72 pounds according to ASTM 473-10 and/or a core hardness of at least 11 pounds. as determined according to ASTM 473-10.

(66) The method of any one of aspects 57-65, the slurry requiring an increase in water demand to maintain the slurry fluidity at the same or lower level that it would be without the high-efficiency lignosulfonate in an otherwise identical slurry containing a polynaphthalene sulfonate instead of the high-efficiency lignosulfonate.

(67) The method of any one of aspects 57-66, wherein the dense layers are formed from one or more dense layer slurries comprising water, stucco, and optionally the high-efficiency lignosulfonate dispersant.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the disclosure but, of course, should not be construed as in any way limiting its scope.

### EXAMPLE 1

This example demonstrates exemplary benefits, including stiffening properties and water-demand, of including high-efficiency lignosulfonate dispersants in gypsum compositions according to principles of embodiments of the disclosure.

In particular, five gypsum slurries, labeled as Slurries 1A-1E, were prepared. The individual slurries included the dispersants as follows: (1A) DILOFLO® CA, which is a polynaphthalene sulfonate (“PNS”) commercially available from GEO® Specialty Chemicals, Inc., Cleveland, Ohio; (1B) Marasperse GNS, a standard range calcium salt lignosulfonate dispersant commercially available from Borregaard® Lignotech Company, headquartered in Sarpsborg, Norway; (1C) Ultrazine NA, an ultrafiltered high-efficiency sodium salt lignosulfonate dispersant commercially available in powder form from Borregaard® Lignotech Company, headquartered in Sarpsborg, Norway; and (1D) Norlig 24C, a standard range blend of calcium salt and sodium salt lignosulfonate dispersant, and (1E) Norlig 11D, a standard range 50% solution of calcium salt lignosulfonate dispersant, both of which are also commercially available from Borregaard® Lignotech Company.

Slurry 1A was prepared as a comparative PNS sample. Slurries 1B, 1D, and 1E contain conventional lignosulfonate dispersants (i.e., not high-efficiency) for comparative purposes. Slurry 1C was prepared using a high-efficiency lignosulfonate dispersant.

For each of Slurries 1A-1E, the respective slurries contained an amount of accelerator, pregelatinized starch, sodium trimetaphosphate (“STMP”), diethylenetriamene pentaacetate (“DTPA”), in addition to the amount of dispersant. The slurries were prepared from a slurry containing stucco in an amount of 100%. As seen in Table 1, the respective water/stucco ratios, stiffening results, and SFS results are also provided.

Slurries 1A-1E were prepared containing the same percentage of accelerator (1%), pregelatinized starch (1%), and STMP (0.10%), by weight of the stucco, respectively. The dispersants included in each of Slurries 1A-1E were provided either in liquid form (i.e., 1A, 1B, and 1E) or solid form (1C and 1D). The dispersants provided in liquid form were included in the respective slurries in an amount of 0.5%. The dispersants provided in solid form were included in the respective slurries in an amount of 0.25% to normalize for active content.

The DTPA amounts were selectively adjusted to match the same stiffening rate (+−5 seconds). Among other things, the amounts were intentionally adjusted so that slurry retardation would not impact the slump measurements. Between the sample slurries, the amount of DTPA varied slightly-Slurry 1A included 0.050%; Slurry 1B included 0.051%; Slurry 1C included 0.048%; Slurry 1D included 0.046%; and Slurry 1E included 0.038%. Each of the amounts are by weight of the stucco (100%). A more substantial reduction of DTPA dosage is also indicative of a retardive action of the used dispersant.

In order to form each of the sample slurries, the respective additives were added to a suitable mixer and mixed for a predetermined amount of time suitable for the mixer (typically less than 30 seconds). In this particular case, the dry ingredients and aqueous solution were initially combined in a laboratory Waring blender, the mixture produced was allowed to soak for 10 seconds, and then the mixture was mixed at high speed for 10 seconds in order to produce the slurry.

Once mixed, the slurries are poured into the slump testing cylinder. Once poured, the size of the slurry patty was measured as well as the stiffening results. If those measurements deviated from the targeted values, adjustments to the total water and DTPA dosage are made until the targets are reached.

The performance of the dispersant in Slurries 1A-1E was measured by targeting the same target for all tests: 7″-8″ diameter patty as measured in accordance with the SFS test and approximately 50 seconds stiffening time. In order to ensure similar SFS results, the total water content was adjusted for Slurries 1A-1E until a diameter of 7″-8″ was achieved. DTPA would be added to achieve similar stiffening results of approximately 50 seconds. The differences in water-demand to achieve these performance benchmarks were measured.

As referred to herein, the SFS test is conducted in the following manner. Briefly, a 2″ (about 5 cm) diameter tube (e.g., with two open ends, one resting on a flat, substantially non-porous surface so as to block the opening) is filled with slurry to a height of 4″ (about 10 cm). Within 5 seconds from sampling and pouring the slurry, the slurry is released onto a flat, level surface by quickly lifting the cylinder, and the released slurry is allowed to spread into a patty. When the slurry has stopped spreading, the widest diameter of the slurry patty (i.e., referred to as the “slump”) is measured (in the case of non-circular (e.g., elliptical) slurry patty, the widest diameter of the slurry patty is averaged with the diameter of the slurry patty in the direction perpendicular to the widest diameter). In some embodiments, a more fluid slurry will typically result in a larger diameter slurry patty.

Gypsum slurries, in accordance with embodiments of the disclosure, can produce patties having any suitable diameter when subjected to the SFS test. By way of example, and not limitation, in some embodiments, the slurry may produce a patty in a range of 4 inches (in) to 10 in, e.g., 4.5 to 10 in; 5 to 10 in; 5.5 to 10 in; 6 to 10 in; 6.5 to 10 in; 7 to 10 in; 7.5 to 10 in; 8 to 10 in; 8.5 to 10 in; 9 to 10 in; 9.5 to 10 in; 6.5 to 8.5 in; 6.5 in to 7.5 in; 6.5 in to 7 in; 7 in to 8.5 in; 7.5 in to 8.5 in, 8 in to 8.5 in; etc.

As referred to herein, to measure the stiffening rate, a test is conducted to record the stiffening rate of each slurry patty. To measure the stiffening properties, each patty is “cut” with a needle. To perform a cut, a needle is inserted through the patty until the tip of the needles reaches the testing surface (e.g., a table). Subsequent cuts are administered every second until the opening created in the slurry patty is no longer “healed” (e.g., no longer closes). The time taken to administer the test is then recorded (in seconds). For the purpose of these experiments, the soaking, mixing and pouring time is included in the final reported stiffening time.

The fluidity was measured in accordance with the SFS test as referred to herein. The stiffening rate was also measured in accordance with the stiffening test as referred to herein.

Table 1 depicts the formulations of Slurries 1A-1E. Table 2 depicts the stiffening and SFS test results of each of Slurries 1A-1E.

TABLE 1

| | 1A | 1B | 1C | 1D | 1E |
|---|---|---|---|---|---|
| | Dispersant (Physical State) | | | | |
| | | Marasperse | Ultrazine | | |
| | PNS | GNS | NA | Norlig 24C | Norlig 11D |
| Ingredient | (Liquid) | (Liquid) | (Solid) | (Solid) | (Liquid) |
| Stucco | 100% | 100% | 100% | 100% | 100% |
| Accelerator | 1% | 1% | 1% | 1% | 1% |
| Pregelatinized Starch | 1% | 1% | 1% | 1% | 1% |
| Sodium | 0.10% | 0.10% | 0.10% | 0.10% | 0.10% |
| Trimetaphosphate | | | | | |
| (STMP) | | | | | |
| Diethylenetriamene | 0.050% | 0.051% | 0.048% | 0.046% | 0.038% |
| Pentaacetate (DTPA) | | | | | |
| Dispersant | 0.5% | 0.5% | 0.25% | 0.25% | 0.50% |
| Water/Stucco Ratio | 0.734 | 0.805 | 0.7443 | 0.8048 | 0.7961 |

TABLE 2

| Test Result | 1A | 1B | 1C | 1D | 1E |
|---|---|---|---|---|---|
| Stiffening (s) | 52 | 54 | 55 | 54 | 56 |
| Slump (in) | 7.6 | 7.8 | 7.4 | 7.1 | 8 |

As seen in Table 2, the inventors discovered that, surprisingly and unexpectedly, the slurry prepared with the high-efficiency lignosulfonate dispersant (Slurry 1C) performed comparably to the slurry prepared with the PNS-based dispersant (Slurry 1A) with respect to water-demand and stiffening properties. Slurries 1B, 1D, and 1E, which were made using standard range (i.e., non high-efficiency) lignosulfonate dispersants, resulted in a higher WSR than Slurries 1A and 1C. The results are advantageous because, as discovered by the present inventors, desirable water-demand and stiffening results are achieved without the use of materials containing or prepared from harmful materials such as PNS, melamine sulfonate, or an aldehyde (such as formaldehyde). The result with high-efficiency lignosulfonate dispersant (1C) also shows no delay of setting time, indicated by a comparable DTPA dosage and stiffening time as the PNS containing formulation (1A).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Stucco and water are fundamental ingredients in a slurry and are thus not considered additives. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. All amounts are by weight and not by volume, unless otherwise indicated. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising:
a set gypsum core disposed between two cover sheets, the core formed from a slurry comprising stucco, water, and a high-efficiency lignosulfonate, the slurry substantially excluding a polynaphthalene sulfonate and melamine sulfonate; the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the slump fluidity spread (SFS) test.

2. The gypsum board of claim 1, wherein the lignosulfonate has a molecular weight of at least 20,000 Da.

3. The gypsum board of claim 1, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

4. The gypsum board of claim 1, wherein the slurry has a water/stucco ratio of from 0.3 to 1.00.

5. The gypsum board of claim 1, wherein the lignosulfonate is provided in an amount of from 0.01% to 5% by weight of the stucco.

6. The gypsum board of claim 1, wherein the lignosulfonate is added to the slurry in a solution containing less than 60% lignosulfonate.

7. The gypsum board of claim 1, wherein the slurry excludes any components containing formaldehyde or other aldehyde, or polymerized in the presence of formaldehyde or other aldehyde.

8. The gypsum board of claim 1, the slurry requiring an increase in water demand to maintain the slurry fluidity at the same or lower level that it would be without the high-efficiency lignosulfonate in an otherwise identical slurry containing a polynaphthalene sulfonate instead of the high-efficiency lignosulfonate.

9. The gypsum board of claim 1, wherein the dense layers are formed from one or more dense layer slurries comprising water, stucco, and optionally the high-efficiency lignosulfonate dispersant.

10. A slurry comprising water, stucco, and a high-efficiency lignosulfonate, the slurry substantially excluding a polynaphthalene sulfonate and melamine sulfonate;
the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the SFS test.

11. The slurry of claim 10, wherein the slurry has a water/stucco ratio of from 0.3 to 0.8.

12. The slurry of claim 10, wherein the lignosulfonate has a molecular weight of at least 20,000 Da.

13. The slurry of claim 10, wherein the lignosulfonate is provided in an amount of from 0.01% to 5% by weight of the stucco.

14. The slurry of claim 10, wherein the lignosulfonate is added to the slurry in a solution containing less than 60% lignosulfonate.

15. The slurry of claim 10, wherein the lignosulfonate is not polymerized by an aldehyde.

16. A method of making gypsum board, the method comprising:
mixing a slurry comprising stucco, water, and a high-efficiency lignosulfonate, the slurry substantially excluding a naphthalene sulfonate and melamine sulfonate, the slurry exhibiting a fluidity that is the same or greater than the fluidity produced by an otherwise identical slurry containing the polynaphthalene sulfonate instead of the high-efficiency lignosulfonate, wherein the high-efficiency lignosulfonate and the polynaphthalene sulfonate have an active content that is the same in the respective slurries, the fluidity measured according to the slump fluidity spread (SFS) test;
placing the slurry between two cover sheets to form a board precursor;
allowing the slurry in the precursor to set to form the board; and
cutting the board, wherein the board has a nail pull resistance of at least 72 pounds according to ASTM 473-10 and/or a core hardness of at least 11 pounds as determined according to ASTM 473-10.

17. The method of claim 16, wherein the lignosulfonate has a molecular weight of at least 20,000 Da.

18. The method of claim 16, wherein the high-efficiency lignosulfonate reduces the water demand of the gypsum slurry by at least 2%, as measured by the SFS test as compared with mono-calcium salt of polymerized aryl alkylsulfonic acids at the same solid content dosage and measured by the same method.

19. The method of claim 16, wherein the lignosulfonate is added to the slurry in a solution containing less than 60% lignosulfonate.

20. The method of claim 16, wherein the slurry has a water/stucco ratio of from 0.3 to 0.8.
